(19) United States
(12) Patent Application Publication
(10) Pub. No.: US 2006/0072257 A1
(43) Pub. Date: Apr. 6, 2006

(54) Device and method for reducing dishing of critical on-chip interconnect lines

(75) Inventors: Rachel Gordin, Hadera (IL); David Goren, Nesher (IL); Sue Ellen Strang, Burlington, VT (US); Kurt Alan Tallman, Essex Junction, VT (US); Youri V. Tretiakov, South Burlington, VT (US)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/954,672

(22) Filed: Sep. 30, 2004

(51) Int. Cl. H02H 9/00

(52) U.S. Cl. 361/56

(57) ABSTRACT

An critical interconnect line (300) for an integrated circuit is provided in which the problem of dishing of copper is addressed. An interconnect line (300) is provided for an integrated circuit in the form of a critical interconnect line modelled as a transmission line. The interconnect line (300) is formed of a conductive material having a width (302) and a length (303). The interconnect line (300) comprises at least two fingers (304, 305, 306) extending the length (303) of the interconnect line (300), an elongate aperture (309) in the conductive material separating two adjacent fingers (304, 305, 306), and one or more bridges (308) joining the fingers (304, 305, 306) at intervals along the length (303) of the interconnect line (300). The fingers (303, 304, 305) are kept within a width for which the effect of dishing acceptable width whilst the bridges (307, 308) keep the fingers (304, 305, 306) at the same potential difference.

### TECHNICAL FIELD

This invention relates to the field of the fabrication of integrated circuits. In particular, this invention relates to a device and method for reducing dishing of selected on-chip interconnect lines.

### BACKGROUND OF THE INVENTION

Development of integrated circuits continues to push the boundaries of miniaturization. On-chip devices are becoming smaller and more numerous which boosts performance but increases the difficulty of wiring them together. The conductivity of the metal used to interconnect the devices is increasingly important. The most commonly used material for metal interconnect lines up to now has been aluminium. However, aluminium imposes limitations on size as it resists the flow of electricity as the wires are made increasingly narrow. Other metals suitable for use in interconnect lines have therefore been sought. Copper has a high conductivity and developments have enabled copper to replace the traditional aluminium interconnect lines in many integrated circuits.

A particular problem arises in the silicon chip standard copper interconnect process, known as the “double damascene” process. Damascene is an interconnection fabrication process in which grooves are formed in an insulating dielectric layer and filled with copper to form the conductive lines. Dual damascene is a multi-level interconnection process in which, in addition to forming the grooves of a single damascene, conductive via openings are also formed.

During the interconnect process, the dielectric layer has a photo-resist material deposited on it. The pattern of the desired interconnect lines is projected onto the photo-resist material using an ultraviolet light. The photo-resist is then washed off with a solvent. The dielectric material in the areas of the projected pattern will have been etched providing grooves in the dielectric material. Copper is then deposited over the dielectric material including in the grooves which will form the interconnect lines. An electro-chemical polishing removes the excess copper from around the interconnect lines, leaving only the copper in the pattern of grooves forming the interconnect lines.

The problem that arises is known as dishing. Dishing means that during the electro-chemical polishing stage of copper interconnects, which removes the extra copper deposited above the desired interconnect lines, the interconnect lines are also slightly polished in the middle. This forms a “belly” or a “dish” shape, hence the name “dishing”. FIG. 1 shows a cross section of a copper interconnect line 101 in a substrate 102 in which the copper interconnect line 101 has been polished into a concave, dish shape 103.

This last undesired polishing decreases the average thickness of the resulting copper interconnects in an uncontrolled and unpredictable manner. This results in an increase in the electrical copper wire resistance in an uncontrolled manner. The problem becomes worse for wider copper wires.

A known solution to this problem is called “cheesing” which is a hole-generation technique. Cheesing involves forming an array of rectangular holes in the copper wire. These holes are filled with the dielectric, which is a much harder material than the copper, and therefore “supports” the copper wire from being dished. The drawback of the cheesing method is that by removing the copper from the hole shapes, the wire resistance becomes larger again but, this time, in a more controlled and predictable manner.

The percentage of copper within any area of a given size on an integrated circuit must fall within a predefined limit. This is called the copper density rule. For example, the copper density may be required to be within 15% and 85%. The density may be checked automatically for every 50 μm square area of an integrated circuit design. The reason for the copper density rule is that the layers within an integrated circuit should be planar and if there is too much or too little copper in a layer the planarity may be compromised.

During the design process of an integrated circuit the layout is designed using computer aided design with software tools for performing various tasks aiding the designer. One of the tasks that may be performed by a software process is instigating the hole-generation if a copper line is proposed in a design which is wider than a threshold for the onset of hole-generation. The software may automatically add holes to the proposed interconnect lines to combat the problem of dishing of the lines.

Another task that may be performed by a software process is checking that in each metal layer the average copper density in square areas of predetermined size is within the required range. If the copper density is not within the required range as it is too low, a pattern fill process may be automatically activated to alter the design to add small areas of copper within the areas of the dielectric to increase the percentage of copper. Similarly, if the copper density is too high, small areas within the interconnect lines may be removed to decrease the percentage of copper.

The design of the interconnect lines with any hole-generation and pattern fill is then used to form the pattern applied as ultraviolet light to the photo-resist mask. Areas of copper fill are etched in the dielectric, whereas areas which will be holes in the interconnect lines are not etched leaving the dielectric material which is then surrounded by the copper when deposited.

FIG. 2 shows a cross-section of two copper interconnect lines 201, 202 in which the copper 203 has rectangular holes 204 which are filled with the dielectric. Pattern fill shapes 205 of copper are also provided in the surrounding dielectric material 206. The metal fill shapes and holes are generated automatically as part of the standard release and tape-out service during the manufacture process.

One or more interconnect lines may be identified as critical in a given design, and while embodiments might be envisaged where all interconnect lines are treated as critical, typically only a small subset of interconnect lines in a design are critical. Critical interconnect lines can be modelled as transmission lines (also referred to as T-lines). Transmission lines have a special geometry in that as well as lines carrying signals they have shielding lines which return current. The shielding lines may be at the side of the signal line such that the transmission line can consist of a single metal layer (coplanar waveguides) or at the bottom such that the signal line can be shielded from a lossy substrate below by means of a ground shield (microstrip lines). Both signal and ground layers can be routed using copper metal layers.

Transmission lines are implemented as electronic devices in an integrated circuit in that they have a parametric structure which can be varied by the designer according to design needs and dimensions. They can be provided as an off-the-shelf device which can be inserted into a design.

Transmission lines are generally the longer interconnect lines carrying high speed signals. Due to this it is important that transmission lines do not encounter the drawbacks of existing hole-generation techniques.

The known hole-generation technique poses several difficulties for transmission lines, as follows:
The hole-generation technique increases the resistance (and hence the insertion loss or signal attenuation at high frequencies) in a manner which is not optimal with respect to the percentage of the removed copper. Resistance is increased, not only due to the metal removal, but also due to significant change of the current path length, which causes an additional resistance increase.
The hole-generation technique modifies the other high frequency parameters of the transmission lines in a complicated and sometimes even unexpected manner.
Modelling of the effects of the hole-generation technique on transmission lines requires full-wave 3D electromagnetic solver simulations, which can be very time-consuming. Interconnect models themselves are highly complex and are not simple for developing, implementing and supporting multiple technologies.
The hole-generation technique has a random character for narrow lines, which can have different hole patterns depending on the line placement and orientation. Such an additional technology variation is highly undesirable since it makes it impossible to predict, beyond a certain accuracy, input and output signal waveforms in a transmission line instance.

As a result of all above drawbacks, it is difficult to accurately predict all transmission line electrical parameters if the transmission lines are formed using the hole-generation technique.

It is an aim of the present invention to provide a solution to the problem of dishing of critical interconnect lines, which also allows minimal disturbance in current flow.

### SUMMARY OF THE INVENTION

According to a first aspect of the present invention there is provided an interconnect line for an integrated circuit in the form of a critical interconnect line modelled as a transmission line formed of a conductive material having a width and a length, the interconnect line comprising: at least two fingers extending the length of the interconnect line; an elongate aperture in the conductive material separating two adjacent fingers; and one or more bridges joining the fingers at intervals along the length of the interconnect line.

Preferably, the one or more elongate apertures are arranged symmetrically with respect to the width of the interconnect line. Bridges may be disposed at each end of an elongate aperture joining the fingers and additional bridges may be disposed at equal intervals along an elongate aperture. The one or more bridges maintain the same potential between the fingers. Preferably, the intervals between the bridges are no more than a tenth of the shortest signal wavelength carried on the interconnect line.

Preferably, each of the fingers has a width less than a threshold value at which a hole-generation technique is applied. This is balanced with the widths of the fingers and the elongate apertures being determined by the desired density of the conductive material. Optimally, the widths of elongate apertures are as narrow as possible within predefined design limits.

The resistance along the interconnect line may be calculated as the resistance of the set of fingers connected in parallel and series by the bridges. The inductance and capacitance may be modelled as a solid interconnect line. The interconnect line may be modelled as a 2D structure.

Preferably, the critical interconnect line carries a signal and has one or more shielding lines and the conductive material is copper.

An integrated circuit may be provided including one or more interconnects as defined in the first aspect of the present invention.

According to a second aspect of the present invention there is provided an integrated circuit comprising: a plurality of on-chip devices; one or more critical interconnect lines connecting the devices; and a dielectric material surrounding the interconnect lines; wherein, a critical interconnect line comprising: at least two fingers extending the length of the interconnect line; an elongate aperture in the conductive material separating two adjacent fingers; and one or more bridges joining the fingers at intervals along the length of the interconnect line.

According to a third aspect of the present invention there is provided a method of determining the layout of a critical interconnect line, comprising: providing a required width for the interconnect line; determining a number of elongate apertures to be arranged across the width of the interconnect line by comparing the required width with a maximal width for a solid metal feature, and a minimal elongate aperture width.

The method may include ensuring that the density of the metal of the interconnect line falls within predetermined range. The method may also include arranging the elongate apertures symmetrically across the width of the interconnect line.

Preferably, the method also includes: providing a required length for the interconnect line; determining a number of bridges to be arranged along an elongate aperture by comparing the required length to a maximum elongate aperture length and a minimum width of bridge. The method may includes placing a bridge at each end of the interconnect line and symmetrically spacing any additional bridges along an elongate aperture.

According to a fourth aspect of the present invention there is provided a computer program product stored on a computer readable storage medium for determining the layout of a critical interconnect line, comprising computer readable program code means for performing the steps of: providing a required width for the interconnect line; determining a number of elongate apertures to be arranged across the width of the interconnect line by comparing the required width with a maximal width for a solid metal feature, and a minimal elongate aperture width.

The computer readable program code means may also performs the steps of: providing a required length for the interconnect line; determining a number of bridges to be arranged along an elongate aperture by comparing the required length to a maximum elongate aperture length and a minimum width of bridge.

The described structure and method solves the dishing problem while providing advantages over the hole-generation technique of the prior art. The resistance increase in the described structure is less for the same percentage of removed copper. In addition, a high predictability is provided due to simpler electrical modelling of the high speed interconnects, and the insensitivity to the wire placement and orientation.

The described structure has carefully calculated longitudinal apertures along the critical interconnect lines. This suggested method is appropriate for selected critical interconnect wires, since its application is more practical during the layout design stage. Such critical interconnect lines are also the best candidates to be designed and modelled as transmission lines (see U.S. patent applications: “An Interconnect-Aware Methodology for Integrated Circuit Design”, U.S. Pat. Ser. No. 10/091,934 filed Mar. 6, 2002 and “Interconnect-Aware Integrated Circuit Design” U.S. Pat. Ser. No. 10/723,752 filed Nov. 26, 2003). The proposed method may be provided as an integral part of the on-chip transmission line layout generation stage.

### BRIEF DESCRIPTION OF THE DRAWINGS

Embodiments of the present invention will now be described, by way of examples only, with reference to the accompanying drawings in which:

FIG. 1 is a cross-section of an interconnect line showing the problem of “dishing”;

FIG. 2 is a cross-section through a structure with two interconnect lines showing “cheesing” as known in the prior art;

FIG. 3 is a plan of an interconnect line in accordance with an aspect of the present invention;

FIG. 4A is a cross-section of an on-chip transmission line with signal and ground interconnect lines as known in the prior art;

FIG. 4B is a cross-section of the on-chip transmission line of FIG. 4A with a longitudinal aperture in accordance with an aspect of the present invention;

FIG. 5 is a flow diagram of an algorithm for selecting the number of elongated apertures in an interconnect line in accordance with an aspect of the present invention;

FIG. 6 is a flow diagram of an algorithm for selecting the number of shorts along a length of an elongated aperture in an interconnect line in accordance with an aspect of the present invention; and

FIG. 7 is a block diagram of a computer system with design tools in accordance with an aspect of the present invention.

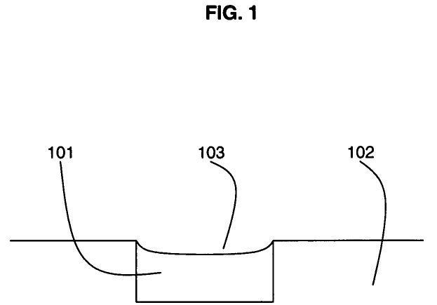

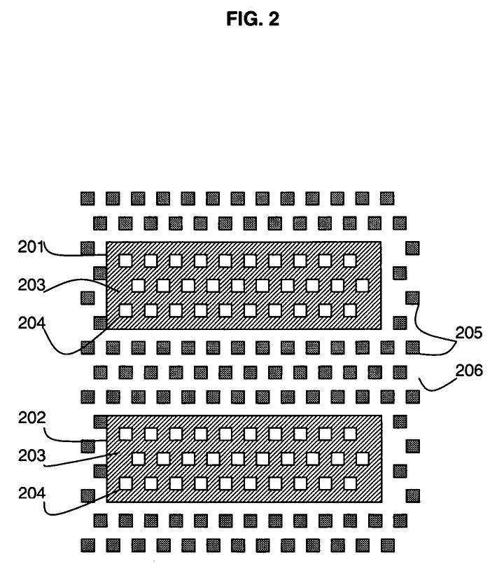

### DESCRIPTION OF PREFERRED EMBODIMENTS

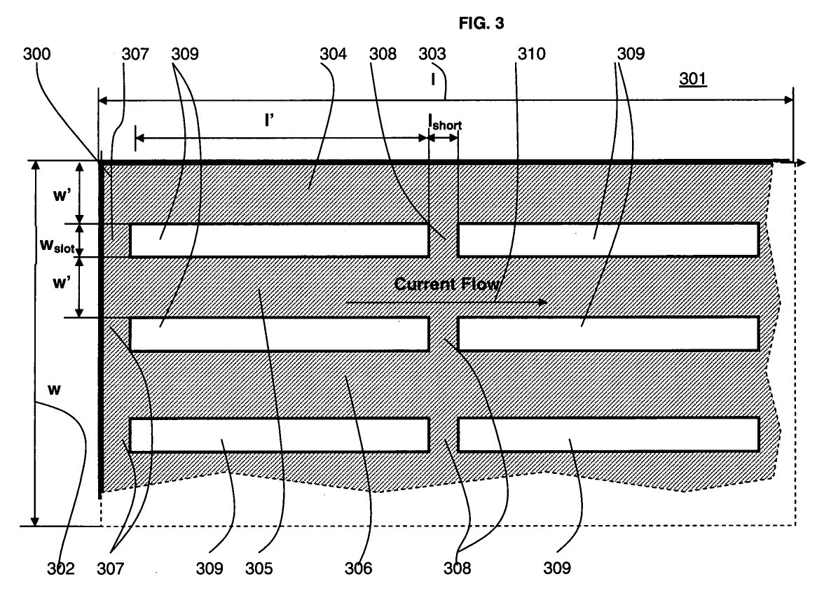

Referring to FIG. 3, an interconnect line 300 is provided supported in an insulating dielectric surrounding material 301. The interconnect line 300 is a critical on-chip copper interconnect line which may be modelled as a transmission line. The interconnect line 300 may be implemented in SiGe/BiCMOS/RFCMOS or standard CMOS process technology and may be a transmission line such as a “microstrip line”, “coplanar waveguide”, etc.

The interconnect line 300 has a width 302 and a length 303. The interconnect line 300 is split into a plurality of fingers or strips 304, 305, 306 across the width 302 of the interconnect line 300. The fingers 304, 305, 306 extend the length 303 of the interconnect line 300. The fingers 304, 305, 306 are connected at intervals along the length 303 of the interconnect line 300 by shorts or bridges 307, 308. The shorts 307, 308 maintain the same potential between the different fingers 304, 305, 306 of the interconnect line 300. The fingers 304, 305, 306 are defined by longitudinal apertures or slots 309 in the interconnect line 300 which are filled with the dielectric material 301.

The interconnect line 300 has width 302 “w” and length 303 “l”. The fingers 304, 305, 306 are each of width “w′” and the slots 309 are each of width “wₛₗₒₜ,”. The length of the slots 309 is length “l′”. The shorts 307, 308 have a width “lₛₕₒᵣₜ”.

The direction of current flow 310 along the interconnect line 300 is shown. The current flows 310 along each of the fingers 304, 305, 306 and therefore, the path of the current is equal in length to the interconnect line length “l” 303 as the current can flow straight along the fingers 304, 305, 306.

It has been found that an optimum interval “l′” between the shorts 307, 308 is no more than a tenth of the shortest signal wavelength. The spacing has a relationship to the speed of the signal, so the highest speed signal is used. In practice, a spacing of approximately 50 μm is used.

The choice of the dimensions of the slots depends on a balance between the copper density rule and the onset of hole-generation in an interconnect line. If the required copper density is M %, then the following dimensions may be used:

$${w}_{slot} = Min\_Design \_Space {w}^{′} < \frac{M}{1 - M} \cdot {w}_{slot} \qquad ( 1 )$$

where “Min_Design_Space” is the minimum design separation of metal lines at the copper level of interest.

### EXAMPLE 1

As an example, if the maximum required copper density, M=0.8 (80%), then w′=4wₛₗₒₜ. For example, in a lower level metal layer of an integrated circuit, wₛₗₒₜ=0.2 μm and hence w′=0.8 μm.

Due to the provision of slots 309, each of the fingers 304, 305, 306 may be sufficiently narrow for the effects of “dishing” during the polishing of a structure containing the interconnect line 300 to be negligible. Dishing, as described in the discussion of the background art, occurs when copper interconnect lines are polished. The copper across the width of the interconnect line is eroded in a concave manner compared to the surrounding material. Dishing is more pronounced as the width of the interconnect line increases. Therefore, at a predetermined width, the standard manufacturing approach is to carry out a hole-generation technology (also known as “cheesing”) in which holes in the copper are filled with the dielectric in order to prevent the erosion.

It is highly preferably to avoid the onset of the use of the hole-generation technique. Therefore, each of the fingers 304, 305, 306 is provided with a width “w′” which is less than the predetermined width for the onset of the hole-generation technique. In this way, an overall width “w” of an interconnect line 300 can be provided which is multiple times the order of the width at which the hole-generation technique would normally be used.

In addition to the fingers 304, 305, 306 being as wide as possible without the onset of the hole-generation, the slots 309 are preferably as narrow as possible whilst the overall copper density must be satisfied.

For example, the if an integrated circuit is manufactured with the hole-generation process starting when w>1.2 μm, the choice of w′=0.8 μm in Example 1 above would be good, since it guarantees that the fingers 304, 305, 306 will be manufactured as solid pieces of metal and not with the hole-generation technique.

In the Example 1, an alternative could be to use w′=5 wₛₗₒₜ=1.0 μm. This choice would improve the overall interconnect performance still providing about 83.3% copper metal density.

As a result of the proposed technique, it is no longer required to use any “hole-exclude” metal shapes in the design environment. The copper metal shapes are built from copper “fingers” which are narrower than the low design limit at which hole-generation starts.

### Example 2

Full-wave 3D electromagnetic solver simulations show that in a standard hole generation process which requires for the upper limit 0.8 (80%) copper density, and has a large copper interconnect line width (in which the line width is much greater than the dimension for the onset of hole-generation), the wire resistance is:

$$R ≅ 1.55 {R}_{0} \frac{•}{w} \qquad ( 2 )$$

where R₀ is the copper layer sheet resistivity, l is the length of the copper interconnect line and w is the width of the copper interconnect line without any holes in it.

In a wide structure as shown in FIG. 3 with fingers 304, 305, 306 separated by slots 309, assuming again 0.8 (80%) copper density, the wire resistance is:

$$R ≅ \frac{{w}^{′} + {w}_{slot}}{{w}^{′}} {R}_{0} \frac{•}{w} = 1.25 {R}_{0} \frac{•}{w} . \qquad ( 3 )$$

From equations (2) and (3) it can be seen that the resistance degradation with the structure of FIG. 3 is less severe than for the standard “isotropic” metal hole distribution. In cases where a larger percentage of the copper has to be removed by the standard cheesing process, the advantage of using the suggested method for the same increased percentage of removed copper is even more pronounced.

### Example 3

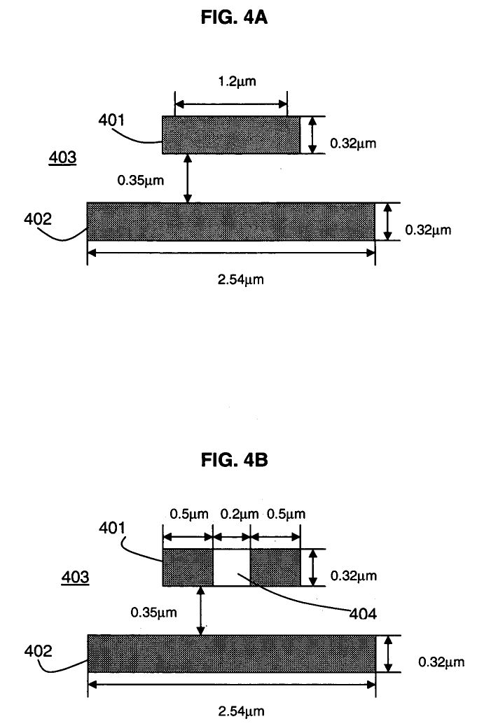

Referring to FIGS. 4A and 4B, a single microstrip transmission line is shown. The single microstrip transmission line has no side shielding and uses two adjacent low metal levels of copper. It is assumed that the width of the signal line is equal to the width of the onset of hole-generation (in this case 1.2 μm).

FIGS. 4A and 4B show signal 401 and ground 402 metal lines in cross section as provided in an integrated circuit structure. The transmission lines 401, 402 are surrounded by an insulating dielectric material 403.

FIG. 4A shows a structure without slots and FIG. 4B shows a structure with a central slot 404.

The simulation results for the structure of FIG. 4A using capacitance and inductance extraction tools QuickCap and QuickInd (trade marks of Random Logic Corporation) as scaled for 50 μm length are as follows:
R_{DC}=3.92[Ohm],
L_{DC}=14.29[pH],
C=11.95 [fF], (4)

The simulation results for the structure of FIG. 4B with the central slot, are as follows:

| | | |
|---|---|---|
| R_{DC} = 4.45 [Ohm] | (+13.5%) | → to be modelled |
| L_{DC} = 14.00[pH] | (−2.0%) | → to be ignored |
| C = 11.70[fF] | (−2.1%) | → to be ignored |

The above case is the worst case since the fingers are forced to have a width of only 0.5 μm rather than 1.0 μm for wide lines, and hole existence effects are stronger for closer signal and ground lines.

This shows that capacitance and inductance (both high and low frequency limits) for the slotted structure of FIG. 4B can be assumed to be practically equal to their values for the one-piece copper line of width w of FIG. 4A.

The determination of the generation of slots to be provided in an interconnect line is now described using the dimension definitions shown in FIG. 3.

Generation of Slots Across the Width of the Line.

w_{Slot} is the constant slot width. This should be the minimal DRC (Design Rule Check) spacing allowed between two metal lines. (For example, a minimal width of slot may be 0.14 μm.)

w₀ is the width of the onset of the standard hole-generation (cheesing) process. This is the narrowest metal feature that can receive metal hole shapes.

kₛₗₒₜ is a factor which multiplies w₀ to set the “onset of slotting”. This is set so that the copper pattern density of wide copper lines is close to but not beyond the limit possible (for example, this may be set at 0.8 (80%)). A higher copper density means a better transmission line performance.

For wide lines:

$$( \frac{{w}^{′}}{{w}^{′} + {w}_{slot}} ) \approx pd$$

pd=copper pattern density fraction

$${k}_{slot} ≅ \frac{pd}{1 - pd} \frac{{w}_{slot}}{{w}_{0}} {w}_{low} = {k}_{slot} \cdot {w}_{0}$$

The suggested slotting algorithm by width is as follows:

| | |
|---|---|
| If, w < w_{low} | → do nothing (no slots) |
| If, w_{low} < w < 2w_{low} + wₛₗₒₜ | → do one slot in the middle. |
| If, 2w_{low} + wₛₗₒₜ < w < | → do two slots in a symmetrical |
| 3w_{low} + 2wₛₗₒₜ | manner. |

This gives:

$$i = number of slots = \vert \frac{w - {w}_{low}}{{w}_{slot} + {w}_{low}} \vert = round ⌊ 0.5 + ( \frac{w - {w}_{low}}{{w}_{slot} + {w}_{low}} ) ⌋$$

(where | | denotes the high integer value)

$${w}^{′} = ( \frac{w - {iw}_{slot}}{i + 1} )$$

and the calculated resistance of the line will be:

$$R = {R}_{0} ( \frac{length}{{w}_{eff}} ) {w}_{eff} = ( i + 1 ) {w}^{′} = w - {iw}_{slot}$$

R₀ is the copper layer sheet resistivity.

Generation of Shorts Along the Length of the Line

l is the total length of the transmission line.

l′<l₀, the length of a slot is less than the maximal slot length, which could be kept to l₀=100 μm for all technologies.

lₛₕₒᵣₜ is the minimal DRC (Design Rule Check) width allowed. (For example, a minimal width may be 0.14 μm.)

The suggested slotting algorithm by length is as follows:

| | |
|---|---|
| If, l < l₀ + 2 lₛₕₒᵣₜ | → no shorts in the middle. (In this |
| | case, maintain whole slots along |
| | the whole transmission line except |
| | the two shorts at each end.) |
| If, l₀ + 2 lₛₕₒᵣₜ < l < 2l₀ + | → do additional one short in the |
| 3 lₛₕₒᵣₜ | middle of the transmission line. |
| If, 2l₀ + 3 lₛₕₒᵣₜ < l < 3l₀ + | → have two shorts in the middle in |
| 4 lₛₕₒᵣₜ | a symmetrical manner. |

This gives:

$$\begin{matrix}j = number of shorts , including the two at each end \\ = 1 + \vert \frac{l - {l}_{short}}{{l}_{0} + {l}_{short}} \vert = 1 + round ⌊ \frac{l - {l}_{short}}{{l}_{0} + {l}_{short}} + 0.5 ⌋ \\ {l}^{′} = ( \frac{l - {jl}_{short}}{j - 1} )\end{matrix}$$

The slotting is therefore defined by the two parameters of i and j while maintaining symmetry.

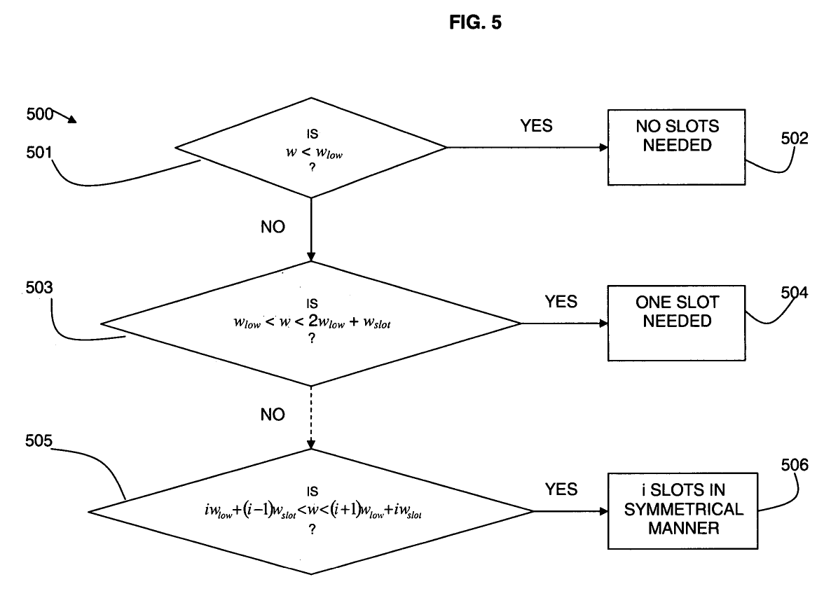

Referring to FIG. 5, an algorithm 500 is shown for choosing the number of slots across the width of an interconnect line.

At step 501, it is determined if any slots are needed in the interconnect line. One or more slots are only required if the width w of the interconnect line is greater than the threshold for the “onset of slotting” w_{low}. Therefore, if it is determined that the width w is sufficiently small, then no slots are needed 502.

If the width w is greater than the threshold w_{low}, it is then determined 503 if one slot is appropriate. This is determined by calculating if the width w is less than the sum of two fingers having slotting onset threshold widths w_{low} and a minimum slot width wₛₗₒₜ. If it is determined that the width w falls within this range 503, then one slot is provided 504.

If the width w is greater than the sum defined as the top end of the range at step 503, then the algorithm proceeds incrementing the number of slots needed. It is determined as shown at step 505, if the width w is in the range for i slots of:
iw_{low}+(i−1)wₛₗₒₜ<w<(i+1)w_{low}+iwₛₗₒₜ

If w is in this range, i slots are provided 506 in a symmetrical manner in the interconnect line.

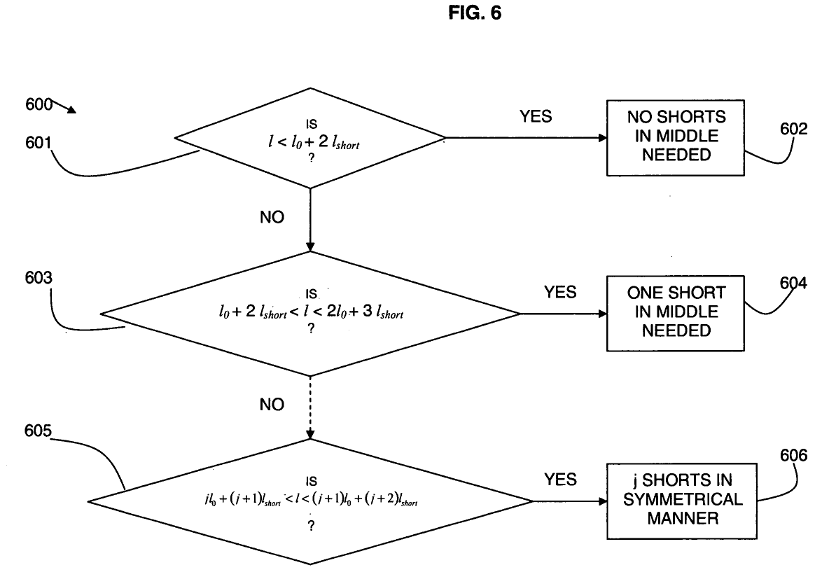

Referring to FIG. 6, an algorithm 600 is shown for choosing the number of shorts along the length of an interconnect line.

At step 601, it is determined if any bridges or shorts are needed in the middle of slots along the length of the interconnect line. Two shorts are provided at either end of a slot and additional shorts are required if the length l of the interconnect line is greater than a maximal slot length, l₀. Therefore, at step 601 it is determined if the line length is less than the maximal slot length l₀ plus the widths of the two shorts at each end, 2lₛₕₒᵣₜ. If so, then no shorts are needed 602 in the middle of the slot.

If the line length l is greater than the threshold defined in step 601, it is then determined 603 if one short is appropriate in the middle of the slot. This is determined by calculating if the line length l is less than the sum of two maximal slot lengths 2l₀ to plus three widths of shorts (one at each end and one in the middle) 3 lₛₕₒᵣₜ If it is determined that the line length l falls within this range 503, then one short is provided 604.

If the line length l is greater than the sum defined as the top end of the range at step 603, then the algorithm proceeds incrementing the number of shorts needed. It is determined as shown at step 605, if the line length is in the range for j slots of:
il₀₄+(i+1)lₛₕₒᵣₜ<l<(i+1)l₀+(i+2)lₛₕₒᵣₜ

If the line length l is in this range, j shorts are provided 606 in a symmetrical manner along the interconnect line.

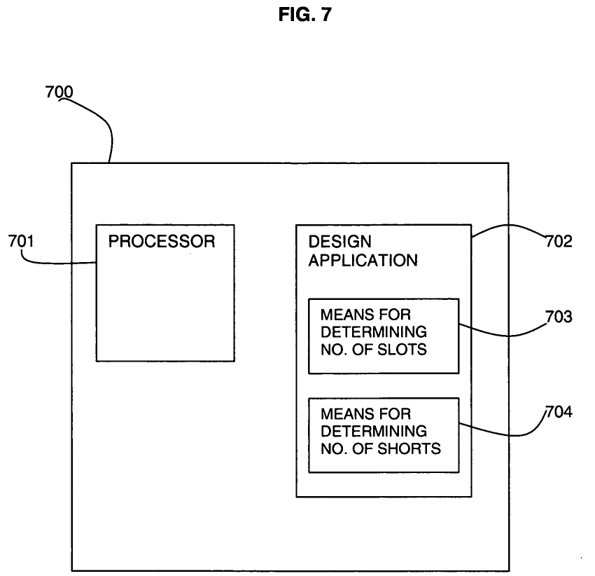

Referring to FIG. 7, a computer system 700 is shown schematically with a processor means 701. A computer software application 702 is provided for the design of the layout of integrated circuits. The application 702 includes software tools for determining the from of a critical interconnect line including means 703 for determining the number of elongate apertures to be arranged across the width of the line and means 704 for determining the number of bridges or shorts required along the length of the line.

The splitting of copper interconnect lines into connected fingers can be carried out as an integral part of an interconnect device parametric cell (Pcell), which creates an instance with newly proposed hole-shapes automatically in a layout view once dimensions and metal layers are specified. One of the preferable requirements is to maintain, where possible, symmetry with respect to conductor centre hole pattern distribution.

The change in transmission line electrical parameters due to elongate apertures present is programmed in a transmission line parametric model, which can be used for time and frequency domain simulations.

The described method allows for copper signal lines to be manufactured with widths larger than current limits for transmission line interconnects.

The finger patterns are uniquely defined for a given copper interconnect line (signal or ground), which means that there is no random character in an interconnect line's properties and behaviour.

When determining the structure of a transmission line, the current direction is known in advance. This enables the arrangement of the slots to be determined in order to minimize current flow disturbance as well as enabling the dishing of wide copper lines to be avoided. The known method of hole-generation does not recognise the direction of the current and provides an isotropic global mask for hole-generation. This imposes holes which are not orientated.

The low frequency resistance of an interconnect line with slots provided in it is trivial to estimate. It is simply the resistance of a set of one-piece rectangular fingers connected in parallel and in series. This can be easily implemented in transmission line models.

The other high frequency transmission line electrical parameters are more easily calculated due to the 2D nature of the described approach compared to the 3D nature of the existing hole-generation process. Therefore, a transmission line can be almost defined by its 2D nature when the length is larger than width, even if this not so, a uniform current can still be assumed in the direction of an interconnect line.

For the described structure, the current length flow is equal to an interconnect line length. For the “isotropic” hole-generation method, the effective current path is always greater than the interconnect length. This causes, for instance, an additional interconnect

resistance degradation, which is difficult to predict. In addition, in the described structure the direction of the current is known as it is along long edges of the rectangular slots.

Also there is no periodic interference with the described slotted structure. The finger shorting every predetermined length of slot has a negligible effect. While in the standard hole-generation approach, there is scattering from the periodic holes at the very high frequencies. This may be important in some high end microwave design applications.

When the width of the fingers is much greater than the width of the slots, the effect of the described method on most (but not all) transmission line parameters at high frequencies can be ignored and the structure can be simply assumed to be a one-piece, whole copper line. The only correction is for the resistance. This has been verified using 2D and 3D EM solver simulations in comparison with the existing hole-generation process effects which are much more severe.

One or more aspects of the present invention may be implemented as a computer program product for designing interconnect line layouts. The computer program product may comprise a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

We claim:

1. An interconnect line for an integrated circuit in the form of a critical interconnect line modelled as a transmission line formed of a conductive material having a width and a length, the interconnect line comprising:
at least two fingers extending the length of the interconnect line;
an elongate aperture in the conductive material separating two adjacent fingers; and
one or more bridges joining the fingers at intervals along the length of the interconnect line.

2. An interconnect line as claimed in claim 1, wherein one or more elongate apertures are arranged symmetrically with respect to the width of the interconnect line.

3. An interconnect line as claimed in claim 1, wherein bridges disposed at each end of an elongate aperture joining the fingers and additional bridges are disposed at equal intervals along an elongate aperture.

4. An interconnect line as claimed in claim 1, wherein the one or more bridges maintain the same potential between the fingers.

5. An interconnect line as claimed in claim 1, wherein the intervals are no more than a tenth of the shortest signal wavelength carried on the interconnect line.

6. An interconnect line as claimed in claim 1, wherein each of the fingers has a width less than a threshold value at which a hole-generation technique is applied.

7. An interconnect line as claimed in claim 1, wherein the widths of the fingers and the elongate apertures are determined by the desired density of the conductive material.

8. An interconnect line as claimed in claim 1, wherein the widths of the elongate apertures are as narrow as possible within predefined design limits.

9. An interconnect line as claimed in claim 1, wherein the resistance along the interconnect line can be calculated as the resistance of the set of fingers connected in parallel and series by the bridges.

10. An interconnect line as claimed in claim 1, wherein the inductance and capacitance are modelled as a solid interconnect line.

11. An interconnect line as claimed in claim 1, wherein the interconnect line is modelled as a 2D structure.

12. An interconnect line as claimed in claim 1, wherein the critical interconnect line carries a signal and has one or more shielding lines.

13. An interconnect line as claimed in claim 1, wherein the conductive material is copper.

14. An integrated circuit including one or more interconnects as claimed in claim 1.

15. An integrated circuit comprising:
a plurality of on-chip devices;
one or more critical interconnect lines connecting the devices; and
a dielectric material surrounding the interconnect lines;
wherein, a critical interconnect line comprising:
at least two fingers extending the length of the interconnect line;
an elongate aperture in the conductive material separating two adjacent fingers; and
one or more bridges joining the fingers at intervals along the length of the interconnect line.

16. A method of determining the layout of a critical interconnect line, comprising:
providing a required width for the interconnect line;
determining a number of elongate apertures to be arranged across the width of the interconnect line by comparing the required width with a maximal width for a solid metal feature, and a minimal elongate aperture width.

17. A method as claimed in claim 16, wherein the method includes ensuring that the density of the metal of the interconnect line falls within predetermined range.

18. A method as claimed in claim 16, wherein the method includes arranging the elongate apertures symmetrically across the width of the interconnect line.

19. A method as claimed in claim 16, wherein the method also includes:
providing a required length for the interconnect line;
determining a number of bridges to be arranged along an elongate aperture by comparing the required length to a maximum elongate aperture length and a minimum width of bridge.

20. A method as claimed in claim 19, wherein the method includes placing a bridge at each end of the interconnect line and symmetrically spacing any additional bridges along an elongate aperture.

21. A computer program product stored on a computer readable storage medium for determining the layout of a critical interconnect line, comprising computer readable program code means for performing the steps of:
providing a required width for the interconnect line;
determining a number of elongate apertures to be arranged across the width of the interconnect line by comparing the required width with a maximal width for a solid metal feature, and a minimal elongate aperture width.

22. A computer program product as claimed in claim 21, wherein the computer readable program code means also performs the steps of:
providing a required length for the interconnect line;
determining a number of bridges to be arranged along an elongate aperture by comparing the required length to a maximum elongate aperture length and a minimum width of bridge.
